(19) United States
(12) Patent Application Publication
(10) Pub. No.: US 2019/0155993 A1
(43) Pub. Date: May 23, 2019

(54) Method and System Supporting Disease Diagnosis

(71) Applicant: ThinkGenetic Inc., Sudbury, MA (US)

(72) Inventors: Peter Lee Wilkerson, Asheville, NC (US); Taylor Cassidy, Sioux Falls, SD (US); Russell Edward Weller, III, Rapid City, SD (US)

(73) Assignee: ThinkGenetic Inc., Sudbury, MA (US)

(21) Appl. No.: 15/818,141

(22) Filed: Nov. 20, 2017

(51) Int. Cl. G06F 19/00; G06N 5/02; G06F 3/0482

(52) U.S. Cl. CPC G06F 19/345; G06F 19/3431; H04L 67/42; G06N 5/022; G06F 3/0482; G06F 19/324

(57) ABSTRACT

A computer-implemented method for supporting disease diagnosis is provided that includes: a) generating and storing a list of user-selected broad symptoms; b) using the list of user-selected broad symptoms to generate and store a list of related disease presentations or diseases; c) using at least one machine knowledge system to identify a collection of disease-specific symptoms that are related to the disease presentations or diseases of the list of related disease presentations or diseases; d) presenting to the user disease-specific symptoms belonging to the collection of disease-specific symptoms for associated user input; e) using the user input associated with the disease-specific symptoms to determine matching scores for diseases presentations or diseases of the list of related disease presentations or diseases; and f) using the matching scores for the diseases presentations or diseases to present to the user rankings or groupings for diseases corresponding to the of the list of related disease presentations or diseases. Other related operations and systems are described and claimed.

### BACKGROUND

### 1. Field

Various embodiments described herein relate generally to the field of health-related predictive analytics, and more particularly to computer systems that match multiple symptoms to possible diseases or disorders.

### 2. Related Art

Rare diseases are often chronic, debilitating, life-threatening and with degenerative progression. They not only have an impact on the patients, but they also have an impact on their family, friends, their physicians and society. A large percentage of rare diseases are genetic in origin and are present throughout a person's life. However, symptoms of such rare diseases my not appear immediately but over time making such rare diseases inherently difficult to diagnose. For example, it can typically take many years for a patient with a rare disease to be properly diagnosed.

The difficulty in diagnosing rare diseases is partly due to lack of knowledge about these diseases within the medical community. For these reasons, persons that experience rare disease symptoms (or their caregivers such as a parent or guardian or other interest party) as well as physicians and medical staff that evaluate such persons increasingly use search engines. However, search engines are not designed for rare diseases. This is because search engines consider pages important when they are linked to by other pages. Rare diseases by definition are unlikely to have a high profile on the web relative to more common diseases. Therefore, the difficulty in diagnosing rare disease continues.

### SUMMARY

In embodiments, a computer-implemented method for supporting disease diagnosis, can involve: a) generating and storing a list of user-selected broad symptoms; b) using the list of user-selected broad symptoms to generate and store a list of related disease presentations or diseases; c) using at least one machine knowledge system to identify a collection of disease-specific symptoms that are related to the disease presentations or diseases of the list of related disease presentations or diseases; d) presenting to the user disease-specific symptoms belonging to the collection of disease-specific symptoms for associated user input; e) using the user input associated with the disease-specific symptoms to determine matching scores for diseases presentations or diseases of the list of related disease presentations or diseases; and f) using the matching scores for the diseases presentations or diseases to present to the user rankings or groupings for diseases corresponding to the of the list of related disease presentations or diseases.

The user input associated with a respective disease-specific symptom of the list of disease-specific symptoms can be selected from the group comprising: i) an indication that the patient/user reports having the respective disease-specific symptom, ii) an indication that the patient/user reports not having the respective disease-specific symptom, and iii) an indication that the patient/user reports possibly having the respective disease-specific symptom.

In embodiments, the list of user-selected broad symptoms can be derived from an initial list of broad symptoms that relate to patient-specific information input by the user. The machine knowledge system(s) can be configured to identify the collection of disease-specific symptoms based on the patient-specific information input by the user. The machine knowledge system(s) can employ computer-implemented rules that represent matching relationships between disease presentations or diseases and disease-specific symptoms.

In further embodiments, the list of disease-specific symptoms as generated in c) can involve the use of a first machine knowledge system that identifies a collection of disease-specific patient experience narratives that are related to disease presentations or diseases in an initial list of related disease presentations or diseases. The user can be presented with the user disease-specific patient experience narratives belonging to the collection of disease-specific patient experience narratives for associated user input. The user input associated with the disease-specific patient experience narratives can be used to update the list of related disease presentations or diseases. A second machine knowledge system can be used to identify a collection of disease-specific symptoms that are related to the updated list of related disease presentations or diseases.

In embodiments, the user input associated with a given disease-specific patient experience narrative can represent an affinity relationship selected from a plurality of affinity relationships that reflect different degrees of similarity between the disease-specific patient experience narrative and the experiences of the patient/user. For example, the plurality of affinity relationships can specify one of four possible options, including: a first option which equates to the situation where the disease-specific patient experience narrative is different from the experience of the patient/user; a second option which equates to the situation where the disease-specific patient experience narrative is not very similar to the experience of the patient/user; a third option which equates to the situation where the disease-specific patient experience narrative is somewhat similar to the experience of the patient/user; and fourth option which equates to the situation where the disease-specific patient experience narrative is very similar to the experience of the patient/user.

In embodiments, the first machine knowledge system can be configured to identify the collection of disease-specific patient experience narratives based on the patient-specific information input by the user, and the second machine knowledge system can be configured to identify the collection of disease-specific symptoms based on the patient-specific information input by the user. The first machine knowledge system can employ computer-implemented rules that represent matching relationships between disease presentations or diseases and disease-specific patient experience narratives, and the second machine knowledge system can employ computer-implemented rules that represent matching relationships between disease presentations or diseases and disease-specific symptoms.

In further embodiments, the list of user-selected broad symptoms as generated in a) can involve presenting to the user broad symptoms for selection by the user in order to generate and store a first list of broad symptoms that have been selected by the user. A third machine knowledge system can be used to generate an initial list of related disease presentations or diseases by identifying one or more disease presentations or diseases that are related to the broad symptoms of the first list of broad symptoms. A fourth machine knowledge system can be used to identify a collection of diseases-related broad symptoms that are related to the disease presentations or diseases of the initial list of related disease presentations or diseases. The diseases-related broad symptoms belonging to the collection of diseases-related broad symptoms can be presented to the user for selection by the user. The initial list of related disease presentations or diseases can be updated based on the user-selections of the diseases-related broad symptoms. The third machine knowledge system can employ computer-implemented rules that represent matching relationships between broad symptoms and disease presentations or diseases, and the fourth machine knowledge system can employ computer-implemented rules that represent matching relationships between disease presentations or diseases and broad symptoms.

In embodiments, the disease-specific symptoms of the list of disease-specific symptoms can be presented to the user in d) before presenting any diseases to the user.

In another aspect, a system for supporting disease diagnosis includes at least one computer processing platform that is configured to carry out a sequence of operations that include: a) generating and storing a list of user-selected broad symptoms; b) using the list of user-selected broad symptoms to generate and store a list of related disease presentations or diseases; c) using at least one machine knowledge system to identify a collection of disease-specific symptoms that are related to the disease presentations or diseases of the list of related disease presentations or diseases; d) presenting to the user disease-specific symptoms belonging to the collection of disease-specific symptoms for associated user input; e) using the user input associated with the disease-specific symptoms to determine matching scores for diseases presentations or diseases of the list of related disease presentations or diseases; and f) using the matching scores for the diseases presentations or diseases to present to the user rankings or groupings for diseases corresponding to the of the list of related disease presentations or diseases.

In embodiments, the at least one computer processing platform can be part of service or portal that is operably coupled to a remote client computer device via data exchange over at least one communication network.

### BRIEF DESCRIPTION OF THE DRAWINGS

FIG. 1 is a schematic view of a networked environment that embodies an electronic service that supports disease diagnosis according to the present disclosure.

FIGS. 2A-2F collectively, is a flow chart illustrating operations carried out by the service of FIG. 1.

FIGS. 3 and 4 are exemplary graphical user interfaces that can be presented to a patient/user by the service as part of the operations of FIGS. 2A-2F.

FIGS. 5A and 5B are schematic diagram illustrating disease scoring methods that can be part of the operations of FIGS. 2A-2F.

FIG. 6 is a schematic diagram illustrating a computing environment in which various embodiments can be implemented.

### DETAILED DESCRIPTION OF THE PREFERRED EMBODIMENTS

The detailed description set forth below is intended as a description of various configurations of the subject technology and is not intended to represent the only configurations in which the subject technology can be practiced. The appended drawings are incorporated herein and constitute a part of the detailed description. The detailed description includes specific details to providing a more thorough understanding of the subject technology. However, it will be clear and apparent that the subject technology is not limited to the specific details set forth herein and may be practiced without these specific details. In some instances, well-known structures and components are shown in block diagram form in order to avoid obscuring the concepts of the subject technology.

It should be noted that while the following description is drawn to a computer based system that supports disease diagnosis, various alternative configurations are also deemed suitable and may employ various computing devices including servers, interfaces, systems, databases, agents, peers, engines, controllers, or other types of computing devices operating individually or collectively. One should appreciate the elements of the system (including the service 15 and the patient/user computing devices 11A, 11B, and 11C) can include one or more processors configured to execute software instructions stored on a tangible, non-transitory computer readable storage medium (e.g., hard drive, solid state drive, RAM, flash, ROM, etc.). The software instructions preferably configure the respective elements to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, web service APIs, or other electronic information exchanging methods. Data exchanges preferably are conducted over one or more packet-switched networks, such as packet switched radio access networks, packed switched carrier core networks, the Internet, LAN, WAN, Wi-Fi, VPN, or other types of IP-based and packet switched networks.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Further, within the context of this document “coupled to” and “coupled with” are also used to mean “communicatively coupled with” over a network, possibly via one or more intermediary nodes.

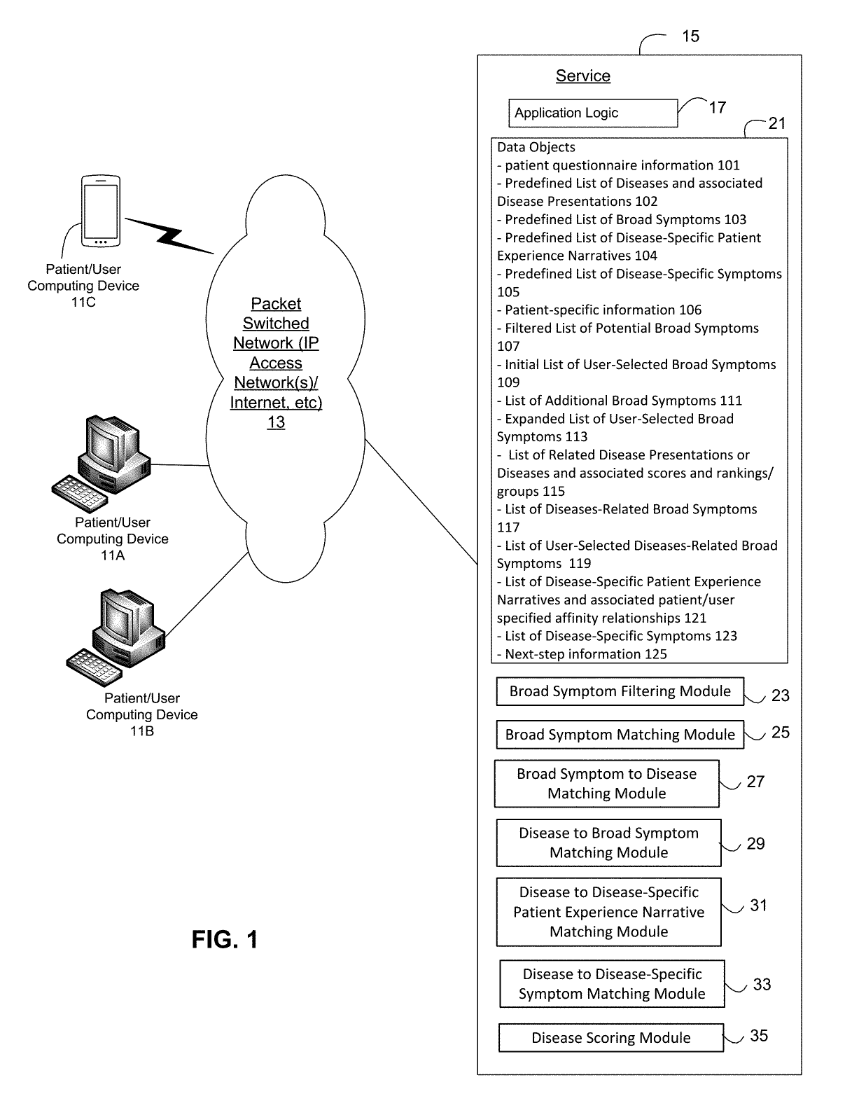

FIG. 1 presents an exemplary service or portal or system 15 that operates to support disease diagnosis. For the purposes of this patent application, disease includes any deviation from or interruption of the normal structure or function of any part, organ, or system (or combination) thereof of the human body, and includes illnesses, disorders, conditions, syndromes and other types of health issues. Disease includes heart, lung and other organ diseases, blood and immune system diseases, cancer, injury, brain and nervous system diseases, endocrine system diseases, infectious and parasitic diseases, pregnancy and childbirth-related diseases, inherited or genetic diseases, and environmentally-acquired diseases. In the example illustrated, a patient/user accesses the service 15 from a remote computing device, such as one of the computing devices 11A, 11B, 11C. The patient/user can be a person that is experiencing one or more symptoms of an unknown disease or can be some other user such as caregiver of that person or heath care professional evaluating that person. The exchange of data between the remote computing device (e.g., computing device 11A or 11B or 11C) and the service 15 can use standardized protocols or algorithms over a packet-switched network 13, such as HTTP, HTTPS, AES, web service APIs, or other electronic information exchanging methods. The computing devices 11A, 11B, 11C each can include one or more processors, a memory system, and one or more communications modules. The computing devices 11A, 11B, 11C can be, for example, mobile computers, tablet computers, mobile devices (e.g., a smartphone or PDA), desktop computers, set top boxes (e.g., for a television), video game consoles, etc. The network 13 can include any one or more of the Internet, a personal area network (PAN), a local area network (LAN), a campus area network (CAN), a metropolitan area network (MAN), a wide area network (WAN), a broadband network (BBN), and the like. Further, the network 13 can include, but is not limited to, any one or more of the following network topologies, including a bus network, a star network, a ring network, a mesh network, a star-bus network, tree or hierarchical network, and the like. The service 15 can include, for example, a stand-alone server, shared servers, dedicated servers, cluster/grid servers (e.g., a server farm), or cloud servers. The service 15 may include one or more processors, a memory system, and one or more communications modules. The service 15 may be configured to distribute workload (e.g., for load balancing) across multiple computing processing platforms.

The service 15 includes application logic 17, several data objects 21, a broad symptom filtering module 23, a broad symptom matching module 25, a broad symptom to disease matching module 27, a disease to broad symptom matching module 29, a disease to disease-specific patient experience narrative matching module 31, a disease to disease-specific symptom matching module 33, and a disease scoring module 35, all of which is described in more detail below.

The data objects 21 are configured to store persistent information that is used across all users of the service, including:
patient questionnaire information 101,
a predefined list of diseases and associated disease presentations 102, which can be developed by input from medical experts, knowledge engineers, clinical evidence and the like,
a predefined list of broad symptoms 103, which can be developed by input from medical experts, knowledge engineers, clinical evidence and the like,
a predefined list of disease-specific patient experience narratives 104, which can be developed by input from medical experts, knowledge engineers, clinical evidence and the like; the patient experience narratives can be written to express corresponding diseases presentations or diseases in terms that are meaningful to the end user; and
a predefined list of disease-specific symptoms 105, which can be developed by input from medical experts, knowledge engineers, clinical evidence and the like.
   In embodiments, the broad symptoms of the list 103 as well as the disease-specific symptoms of the list 105 can be organized in a hierarchy of groups or classes, such as one or more classes that correspond to different body parts or areas, one or more classes that correspond to different body functions, a class pertaining to child development, a class pertaining to cancer, tumors, ulcers and abnormal growths, a class pertaining to feelings and general health, and a class pertaining to the growth and stature. Other hierarchical groupings or classes can also be used.

The data objects 21 are also configured to store session-related information that is generated and/or used for a particular user of the service, including:
patient-specific information 106,
a filtered list of potential broad symptoms 107,
an initial list of user-selected broad symptoms 109,
a list of additional broad symptoms 111,
an expanded list of user-selected broad symptoms 113,
a list of related disease presentations or diseases and associated scores and rankings/groups 115,
a list of diseases-related broad symptoms 117,
a list of user-selected diseases-related broad symptoms 119,
a list of disease-specific patient experience narratives and associated patient/user specified affinity relationships 121,
a list of disease-specific symptoms 123, and
next step information 125 that pertains to particular diseases (such as information on how to prepare for a doctor visit which is related to the particular diseases, researched medical information relating to the particular diseases, and consumer health information related to the particular diseases).
   The data objects 21 can be part of a server-side central database, some other server-side form of data storage, some client-side form of data storage, and/or combinations thereof

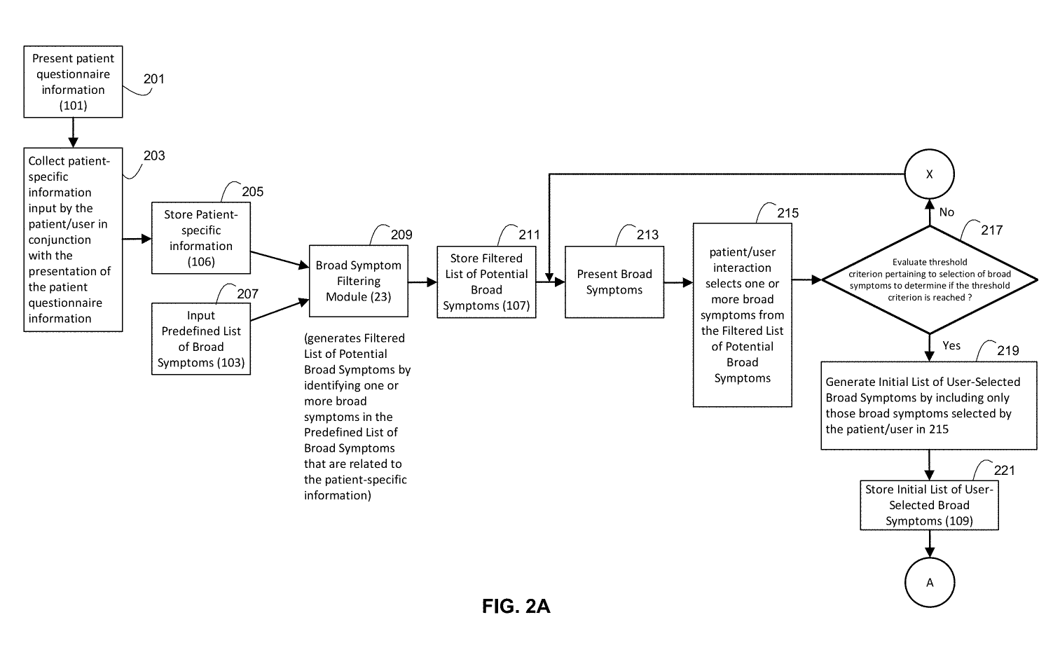

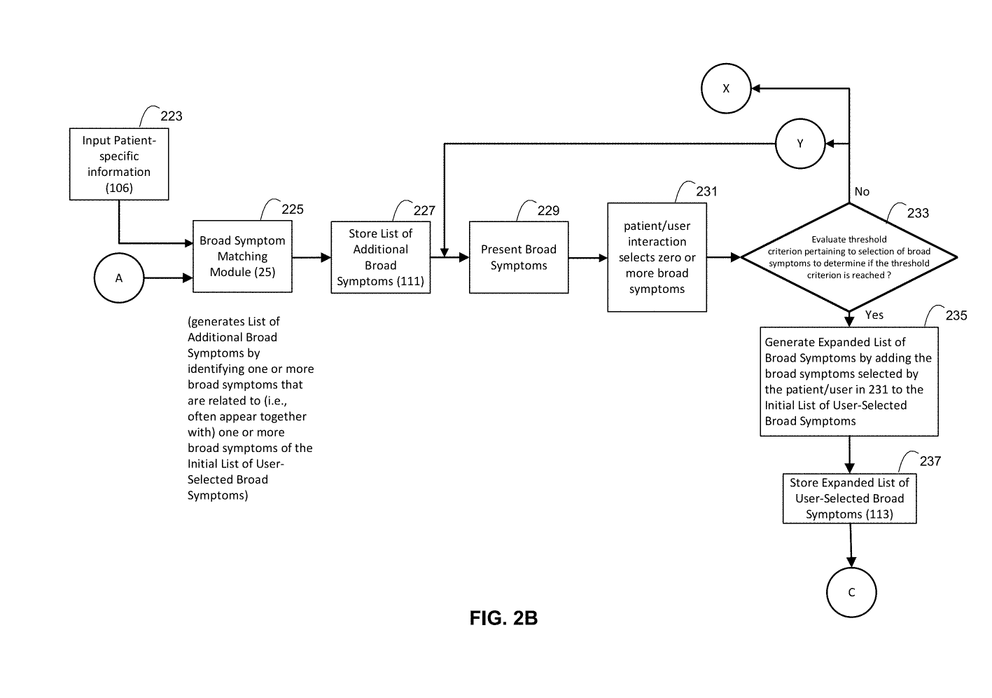

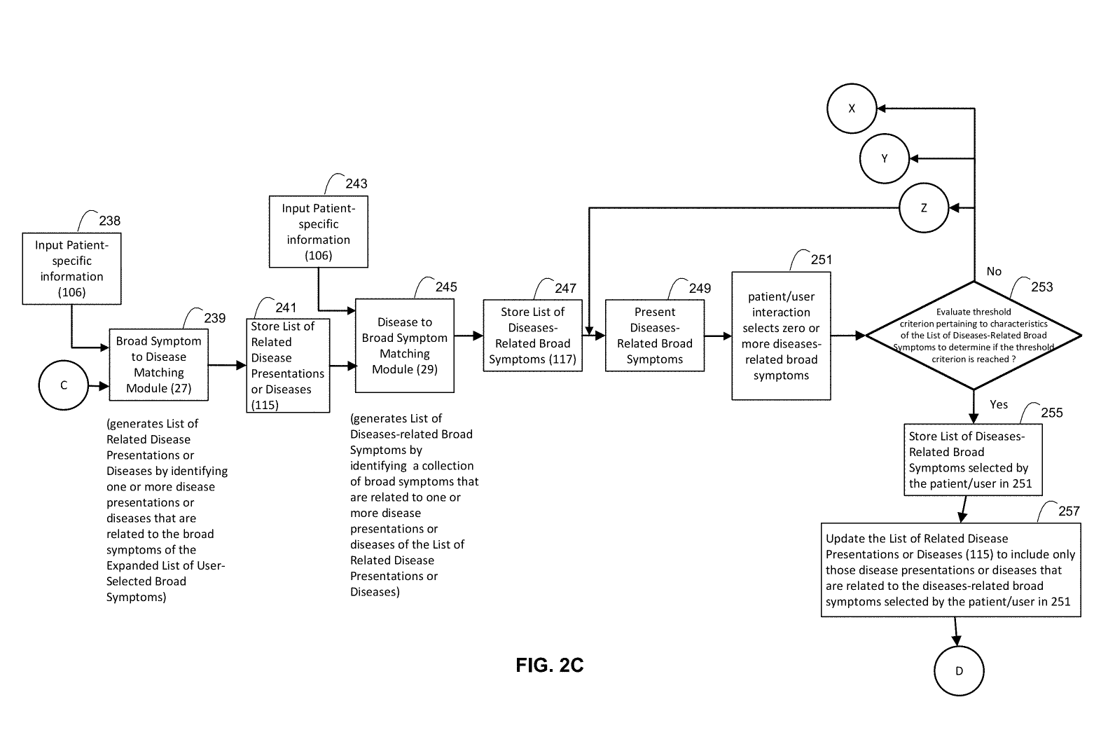

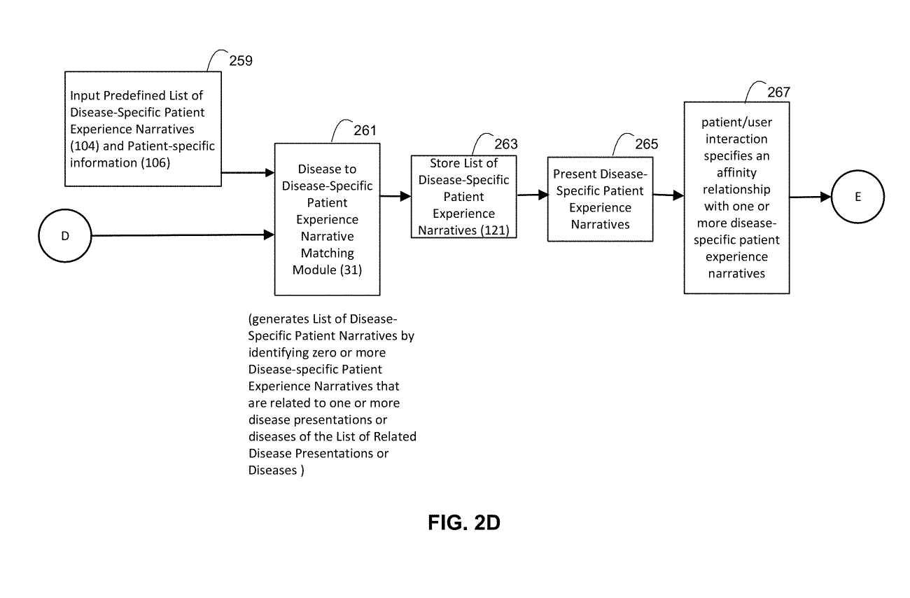

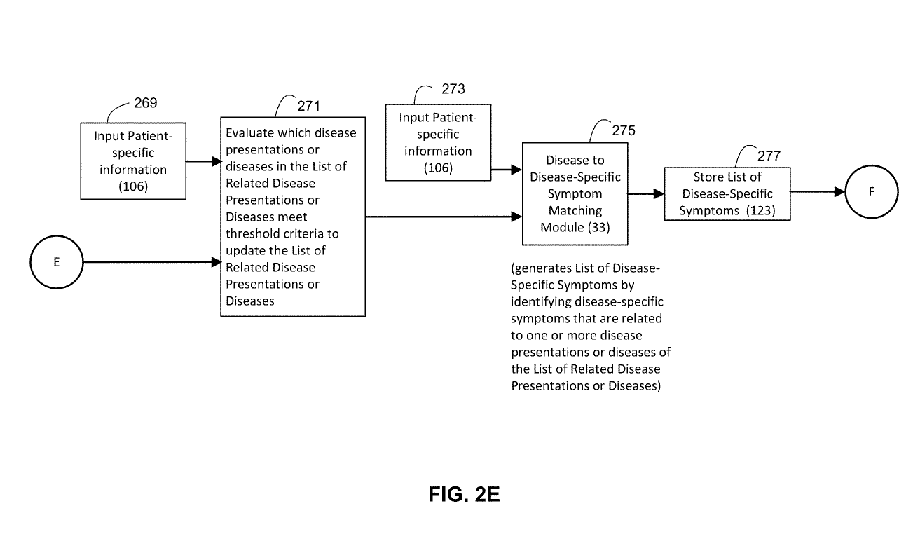

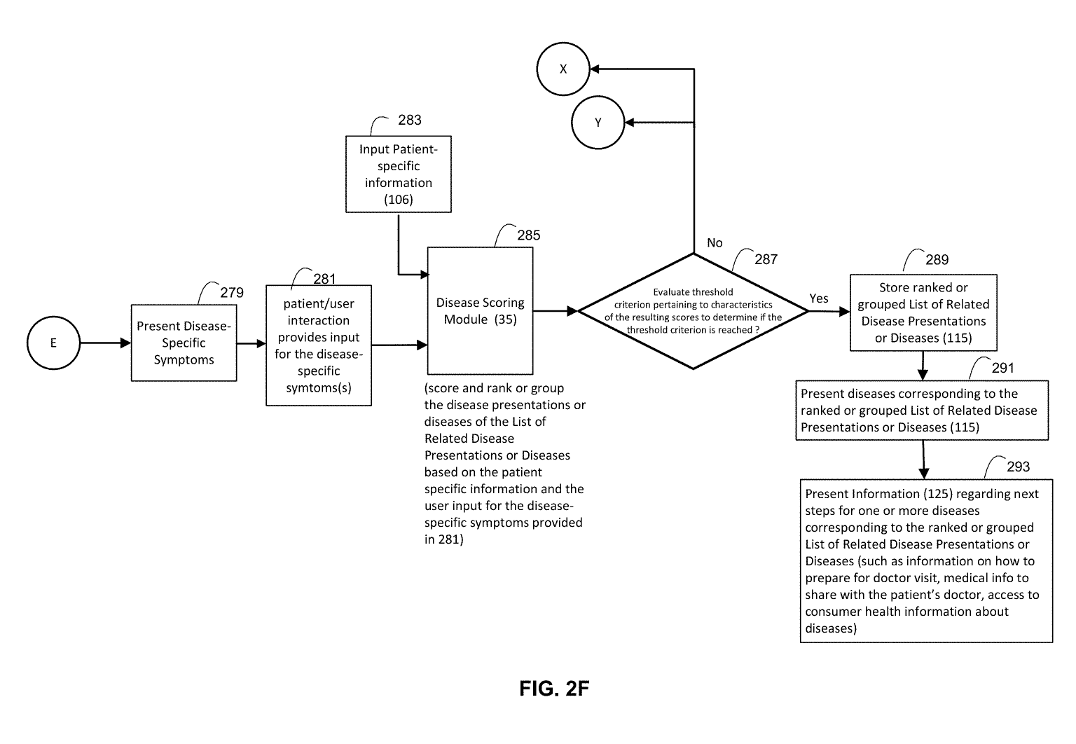

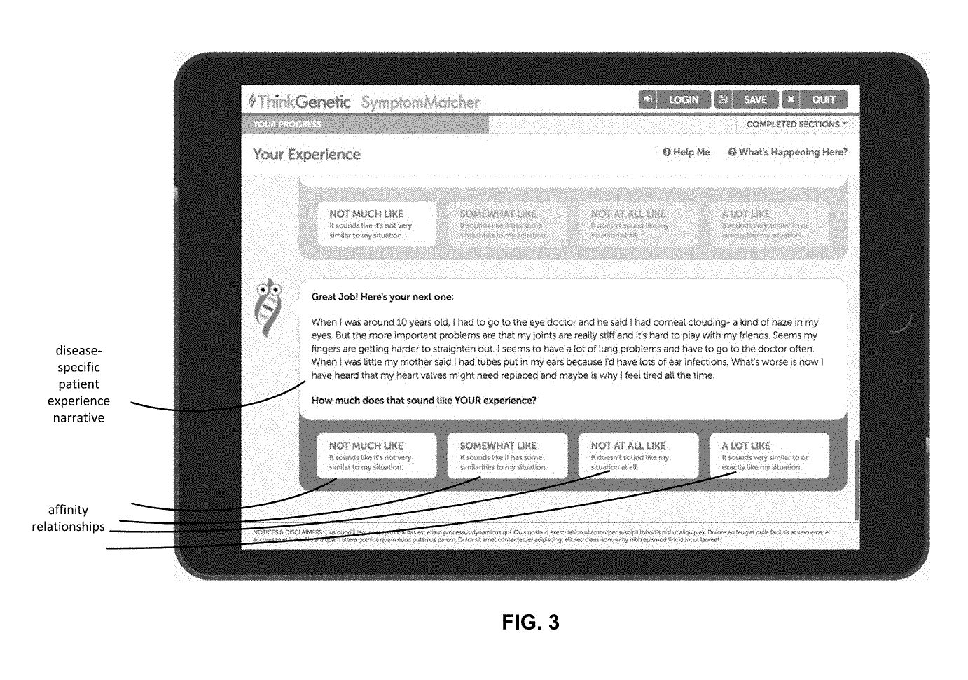

The application logic 17 allows patient/users to access and interact with the service 15 from the remote computing devices 11A, 11B, 11C, etc. operated by the patient/users over the packet switched network 13. In one embodiment, the respective computing devices 11A, 11B, 11C, etc. can establish a connection (e.g., a TCP/IP connection, a session, an asynchronous connection, etc.) with the service 15. Once the connection is established, the service 15 can maintain the connection. The application logic 17 cooperates with one or more applications (such as a web browser or other suitable application) that execute on respective computing devices 11A, 11B, 11C, etc. operated by the patient/users to provide for data exchange that allows for several functions as described below with respect to FIGS. 2A-2F. The data objects 21 used by such functions are based on both disease-specific symptoms and broad symptoms.

The manifestations of a particular disease can vary from person to person as well as vary over time for any one person. As used herein, a “disease presentation” is a manifestation of a particular disease that accommodates for these variations over people and time.

As used herein, each “disease-specific symptom” represents a clinical sign of disease and need not correspond to any one particular disease or disease presentation. It can correspond to one or more diseases or disease presentations. In embodiments, the disease-specific symptoms can be expressed in clear terms that can be understood by the general non-medical public. The terms of the disease-specific symptoms can include one or more attributes, such as duration, level of intensity, and progression over time. In some cases, a non-medical person may or may not can know whether they have a disease-specific symptom sign except when a medical professional informs them of the results of tests, such as “enlarged spleen.” In these cases, one or more disease-specific symptoms that a non-medical person might recognize as present can be used as indicator for the corresponding disease or disease presentation. Additionally, some disease-specific symptoms can represent clinical signs that are not health deficits but statements of normalcy, which help establish whether a disease or disease presentation is present or not. For example, in one disease if a person being examined does not have “normal cognitive development,” then it is very much less likely that they have that disease presentation.

As used herein, a “broad symptom” is a sign of disease but need not correspond to any particular disease or disease presentation. Instead, many of the broad symptoms can correspond to a plurality of diseases or disease presentations and thus can correspond to a plurality of disease-specific symptoms linked to such diseases or disease presentations. In embodiments, the broad symptoms can be expressed in clear terms that can be understood by the general non-medical public.

Note that it is recognized that non-medical people do not catch the subtleties of the clinical signs of various diseases the way a medical professional does. The system and methodology as presented herein recognizes this tendency and seeks to avoid asking the patient/user about disease-specific symptoms until after identifying a list of relevant diseases based upon user selection of broad symptoms. This can reduce the number of disease-specific symptoms that a person needs to consider and thus make the method and service easier to use and more effective.

FIGS. 2A to 2F, collectively, is a flow chart that illustrates exemplary operations carried out by the service 15 to allow a patient/user to access and interact with the service 15 from a remote computing device (e.g., 11A, 11B or 11C). Such operations can be performed to allow a number of patient/users to access and interact with the service 15 from a number of remote computing devices (e.g., 11A, 11B, and 11C) at different times or simultaneously as necessary.

The operations being in block 201 where patient questionnaire information (101) stored as a data object 21 is presented (displayed) to the patient/user through operation of the remote computing device.

In block 203, the service 15 collects patient-specific information input by the patient/user in conjunction with the presentation (display) of the patient questionnaire information in 201 on the remote computing device. In embodiments, such patient-specific information can include age of the patient, gender of the patient, and possibly other traits or information specific to the patient.

In block 205, the service 15 stores the patient-specific information (106) collected in 203 as a data object 21.

In block 209, the broad symptom filtering module 23 is configured, taking as input the predefined list of broad symptoms in 207 and the patient-specific information 106 stored in 205, to generate the filtered list of potential broad symptoms by identifying one or more broad symptoms in the predefined list of broad symptoms (103) that are related to or match the patient-specific information (106). In embodiments, the broad symptom filtering module 23 can employ computer-implemented rules that represent matching relationships between the patient-specific information (106) and one or more broad symptoms. Such computer-implemented rules can be evaluated to identify one or more broad symptoms that match the patient-specific information, and each identified broad symptom can be added to the filtered list of potential broad symptoms. The computer-implemented rules can be based on clinical evidence and/or expert opinions that support the matching relationships between patient-specific information and one or more broad symptoms.

In block 211, the service 15 stores the filtered list of potential broad symptoms (107) as a data object 21.

In block 213, the broad symptoms that belong to the filtered list of potential broad symptoms as stored in 211 are presented (displayed) to the patient/user through operation of the remote computing device.

In block 215, the service 15 collects data representing broad symptoms that are selected by the patient/user in conjunction with the presentation of broad symptoms that belong to the filtered list of potential broad symptoms in 213 on the remote computing device. In embodiments, the broad symptoms that belong to the filtered list of potential broad symptoms can be presented (displayed) to the patient/user in different groups or classes according to the hierarchal structure of groups or classes for the broad symptoms as discussed above. The patient/user can select a particular broad symptom by one or more predefined input actions, such as by clicking on a check box or field that is displayed adjacent text representing the particular broad symptom or by highlighting/clicking the text representing the particular broad symptom itself

In block 217, the service 15 evaluates threshold criterion pertaining to selection of broad symptoms in 215 to determine if the threshold criterion is reached. For example, the threshold criteria can involve a count of broad symptoms selected by the user, a minimum threshold for this count, a preliminary score based on the broad symptoms selected by the user, other user activity or inactivity, and possibly time constraints. If the threshold criterion is not reached, the operations revert back to repeat blocks 213 to 217 where the patient/user is presented with potential broad symptoms and the service 15 continues to collect data representing broad symptoms that are selected by the patient/user. After some number of reversions of blocks 213 to 217 where the threshold criterion is not reached, the service 15 can notify the patient/user that the service is unable to identify a disease based on the inputs provided by the patient/user. The service 15 can optional provide contact details or other suggestions to the patient/user for how to proceed in this case. If the threshold criterion is reached, the operations continue to block 219 where the initial list of user-selected broad symptoms (109) is generated by including only those broad symptoms that have been selected by the patient/user as dictated by the data collected in 215.

In block 221, the service 15 stores the initial list of user-selected broad symptoms (109) as a data object 21.

In block 225, the broad symptom matching module 25 is configured, taking as input the initial list of user-selected broad symptoms 109 stored in 221 and the patient-specific information 106 in 223, to generate a list of additional broad symptoms by identifying one or more additional broad symptoms that are related to (i.e., often appear together with) one or more broad symptoms of the initial list of user-selected broad symptoms 109 stored in 221. In embodiments, the broad symptom matching module 25 can employ computer-implemented rules that represent matching relationships between broad symptoms as well as computer-implemented rules that represent matching relationships between the patient-specific information (106) and one or more broad symptoms. Such computer-implemented rules can be evaluated to identify one or more broad symptoms that match the broad symptoms of the initial list of user-selected broad symptoms 109 stored in 221 as well as the patient-specific information 106 that is input in 223, and each identified broad symptom that is not part of the initial list of user-selected broad symptoms 109 stored in 221 can be added to the list of additional broad symptoms. The computer-implemented rules can be based on clinical evidence and/or expert opinions and/or information theory that support the matching relationships between broad symptoms.

In block 227, the service 15 stores the list of additional broad symptoms (111) as a data object 21.

In block 229, the broad symptoms belonging to the list of additional broad symptoms stored in 227 are presented (displayed) to the patient/user through operation of the remote computing device.

In block 231, the service 15 collects data representing broad symptoms that are selected by the patient/user in conjunction with the presentation (display) of broad symptoms in 229 on the remote computing device. In embodiments, the broad symptoms that belong to the list of additional broad symptoms can be presented (displayed) to the patient/user in different groups or classes according to the hierarchal structure of groups or classes for the broad symptoms as discussed above. The patient/user can select a particular broad symptom by one or more predefined input actions, such as by clicking on a check box or field that is displayed adjacent text representing the particular additional broad symptom or by highlighting/clicking the text representing the particular additional broad symptom itself.

In block 233, the service 15 evaluates threshold criterion pertaining to selection of broad symptoms in 231 to determine if the threshold criterion is reached. For example, the threshold criteria can involve a count of broad symptoms selected by the user, a minimum threshold for this count, a preliminary score based on the broad symptoms selected by the user, other user activity or inactivity and possibly time constraints. If the threshold criterion is not reached, the operations can revert back to blocks 229 and 233 where the patient/user is presented with broad symptoms and the service 15 continues to collect data representing broad symptoms that are selected by the patient/user (or possibly reverts back to blocks 213 to 217 where the patient/user is presented with potential broad symptoms and the service 15 collects data representing broad symptoms that are selected by the patient/user). After some number of reversions of blocks 229 to 233 where the threshold criterion of 233 is not reached, the service 15 can notify the patient/user that the service is unable to identify a disease based on the inputs provided by the patient/user. The service 15 can optional provide contact details or other suggestions to the patient/user for how to proceed in this case. If the threshold criterion of 233 is reached, the operations continue to block 235 where the expanded list of broad symptoms is generated by adding the broad symptoms selected by the patient/user (as dictated by the data collected in 231) to the initial list of user-selected broad symptoms (109) stored in 221.

In block 237, the service 15 stores the expanded list of broad symptoms (113) as a data object 21.

In block 239, the broad symptom to disease matching module 27 is configured, taking as input the expanded list of broad symptoms 113 stored in 237 and the patient-specific information 106 in 238, to generate a list of related disease presentations or diseases by identifying one or more disease presentations or diseases that are related to one or more broad symptoms of the expanded list of broad symptoms 113 stored in 237. In embodiments, the broad symptom to disease matching module 27 can employ computer-implemented rules that represent matching relationships between broad symptoms and disease presentations or diseases as well as computer-implemented rules that represent matching relationships between the patient-specific information (106) and one or more disease presentations or diseases. Such computer-implemented rules can be evaluated to identify one or more disease presentations or diseases that match the broad symptoms of the expanded list of broad symptoms 113 stored in 237 as well as the patient-specific information 106 input in 238, and each identified disease presentation or disease can be added to the list of related disease presentations or diseases. The computer-implemented rules can be based on clinical evidence and/or expert opinions and/or information theory that support the matching relationships between broad symptoms and disease presentations or diseases. In other embodiments, other machine knowledge systems, such as supervised machine learning systems and unsupervised machine learning systems, can be used. Supervised machine learning systems derive an inference function from labeled training data. The training data consist of a set of training examples, where each example is a pair consisting of an input object (typically a vector) and a desired output value (also called the supervisory signal). A supervised learning algorithm analyzes the training data and produces the inference function, which can be used for mapping new examples. An optimal scenario will allow for the algorithm to correctly determine the class labels for all feasible inputs. Unsupervised machine learning systems draw inferences from datasets consisting of input data without labeled responses. The most common unsupervised learning method is cluster analysis, which is used for exploratory data analysis to find hidden patterns or grouping in data. The clusters are modeled using a measure of similarity which is defined upon metrics such as Euclidean or probabilistic distance. Common clustering algorithms include: Hierarchical clustering (which builds a multilevel hierarchy of clusters by creating a cluster tree); k-Means clustering (which partitions data into k distinct clusters based on distance to the centroid of a cluster); Gaussian mixture models (which models clusters as a mixture of multivariate normal density components); Self-organizing maps (which is uses neural networks that learn the topology and distribution of the data); and Hidden Markov models (which use observed data to recover sequence of states).

In block 241, the service 15 stores the list of related disease presentations or diseases (115) as a data object 21.

In block 245, the disease to broad symptom matching module 29 is configured, taking as input the list of related disease presentations or diseases 115 stored in 241 and the patient-specific information 106 in 243, to generate a list of diseases-related broad symptoms by identifying a collection of broad symptoms (preferably from the filtered list of potential broad symptoms stored in 211) that are related to one or more disease presentations or diseases of the list of related disease presentations or diseases 115 stored in 241. In embodiments, the disease to broad symptom matching module 29 can employ computer-implemented rules that represent matching relationships between disease presentations or diseases and broad symptoms as well as computer-implemented rules that represent matching relationships between the patient-specific information (106) and one or more broad symptoms. Such computer-implemented rules can be evaluated to identify a collection of broad symptoms that match the one or more disease presentations or diseases of the list of related diseases 115 stored in 241 as well as the patient-specific information 106 input in 243, and each identified broad symptom can be added to the list of diseases-related broad symptoms. The computer-implemented rules can be based on clinical evidence and/or expert opinions that support the matching relationships between diseases and broad systems. In other embodiments, other machine knowledge systems, such as supervised machine learning systems and unsupervised machine learning systems, can be used. Supervised machine learning systems derive an inference function from labeled training data. The training data consist of a set of training examples, where each example is a pair consisting of an input object (typically a vector) and a desired output value (also called the supervisory signal). A supervised learning algorithm analyzes the training data and produces the inference function, which can be used for mapping new examples. An optimal scenario will allow for the algorithm to correctly determine the class labels for all feasible inputs. Unsupervised machine learning systems draw inferences from datasets consisting of input data without labeled responses. The most common unsupervised learning method is cluster analysis, which is used for exploratory data analysis to find hidden patterns or grouping in data. The clusters are modeled using a measure of similarity which is defined upon metrics such as Euclidean or probabilistic distance. Common clustering algorithms include: Hierarchical clustering (which builds a multilevel hierarchy of clusters by creating a cluster tree); k-Means clustering (which partitions data into k distinct clusters based on distance to the centroid of a cluster); Gaussian mixture models (which models clusters as a mixture of multivariate normal density components); Self-organizing maps (which is uses neural networks that learn the topology and distribution of the data); and Hidden Markov models (which use observed data to recover sequence of states).

In block 247, the service 15 stores the list of diseases-related broad symptoms (117) as a data object 21.

In block 249, the diseases-related broad symptoms that belong to the list of diseases-related broad symptoms as stored in 247 are presented (displayed) to the patient user through operation of the remote computing device.

In block 251, the service 15 collects data representing broad symptoms that are selected by the patient/user in conjunction with the presentation (display) of the list of diseases-related broad symptoms in 249 on the remote computing device. In embodiments, the broad symptoms that belong to the list of diseases-related broad symptoms can be presented (displayed) to the patient/user in different groups or classes according to the hierarchal structure of groups or classes for the broad symptoms as discussed above. The patient/user can select a particular diseases-related broad symptom by one or more predefined input actions, such as by clicking on a check box or field that is displayed adjacent text representing the particular diseases-related broad symptom or by highlighting/clicking the text representing the particular diseases-related broad symptom itself. In embodiments, the system can propagate the user-selected broad symptoms represented by the expanded list of broad symptoms (113) as part of the diseases-related broad symptoms selected by the user in 251. In this manner, the system can remember the user selections pertaining to the expanded list of broad symptoms (113) and uses this information to identify the diseases-related broad symptoms selected by the user in 251.

In block 253, the service 15 evaluates threshold criterion pertaining to selection of the diseases-related broad symptoms in 251 to determine if the threshold criterion is reached. For example, the threshold criteria can involve a count of broad symptoms selected by the user, a minimum threshold for this count, a preliminary score based on the broad symptoms selected by the user, other user activity or inactivity and possibly time constraints. If the threshold criterion is not reached, the operations can revert back to blocks 249 and 251 where the patient/user is presented with diseases-related broad symptoms and the service 15 continues to collect data representing diseases-related broad symptoms that are selected by the patient/user (or possibly reverts back to blocks 229 and 231 where the patient/user is presented with broad symptoms and the service 15 collects data representing additional broad symptoms that are selected by the patient/user, or possibly reverts back to blocks 213 and 215 where the patient/user is presented with broad symptoms and the service 15 collects data representing broad symptoms that are selected by the patient/user). After some number of reversions of blocks 249 to 253 where the threshold criterion of 253 is not reached, the service 15 can notify the patient/user that the service is unable to identify a disease based on the inputs provided by the patient/user. The service 15 can optional provide contact details or other suggestions to the patient/user for how to proceed in this case. If the threshold criterion of 253 is reached, the operations continue to block 255.

In block 255, the service 15 stores the list of user-selected diseases-related broad symptoms (119) as a data object 21.

In block 257, the service 15 updates the list of related disease presentations or diseases 115 to include only those disease presentations or diseases that are related to the broad symptoms in the list of user-selected diseases-related broad symptoms 119 stored in 255. In embodiments, the update to the list of related disease presentations or diseases 115 can involve operations of the broad symptom to disease matching module 27 that identify one or more disease presentations or diseases that match one or more broad symptoms of the list of user-selected diseases-related broad symptoms 119 stored in 255 according to a predetermined matching criterion. Such identified disease presentations or diseases can be merged into the list of related disease presentations or diseases 115 as stored by the service whereby any of the identified disease presentations or diseases that are not yet included in the list of related disease presentations or diseases 115 are added to the list of related disease presentations or diseases 115 stored by the service.

In block 261, the disease to disease-specific patient experience narrative matching module 31 is configured, taking as input the list of related disease presentations or diseases 115 determined in 257 as well as the predefined list of disease-specific patient experience narratives 104 and the patient-specific information 106 in 259, to generate a list of disease-specific patient experience narratives by identifying zero or more disease-specific patient experience narratives that are related to one or more disease presentations or diseases of the list of related diseases presentations or diseases determined in 257. In embodiments, the disease to disease-specific patient experience narrative matching module 31 can employ computer-implemented rules that represent matching relationships between disease presentations or diseases and disease-specific patient experience narratives as well as computer-implemented rules that represent matching relationships between the patient-specific information (106) and one or more disease-specific patient experience narratives. Such computer-implemented rules can be evaluated to identify zero or more disease-specific patient experience narratives from the predefined list of disease-specific patient experience narratives 104 that match the one or more diseases of the list of related disease presentations or diseases 115 determined in 257 as well as the patient-specific information 106 input in 259, and each identified disease-specific patient experience narrative can be added to the list of disease-specific patient experience narratives. The computer-implemented rules can be based on clinical evidence and/or expert opinions and/or information theory that support the matching relationships between disease presentations or diseases and disease-specific patient experience narratives. In other embodiments, other machine knowledge systems, such as supervised machine learning systems and unsupervised machine learning systems, can be used. Supervised machine learning systems derive an inference function from labeled training data. The training data consist of a set of training examples, where each example is a pair consisting of an input object (typically a vector) and a desired output value (also called the supervisory signal). A supervised learning algorithm analyzes the training data and produces the inference function, which can be used for mapping new examples. An optimal scenario will allow for the algorithm to correctly determine the class labels for all feasible inputs. Unsupervised machine learning systems draw inferences from datasets consisting of input data without labeled responses. The most common unsupervised learning method is cluster analysis, which is used for exploratory data analysis to find hidden patterns or grouping in data. The clusters are modeled using a measure of similarity which is defined upon metrics such as Euclidean or probabilistic distance. Common clustering algorithms include: Hierarchical clustering (which builds a multilevel hierarchy of clusters by creating a cluster tree); k-Means clustering (which partitions data into k distinct clusters based on distance to the centroid of a cluster); Gaussian mixture models (which models clusters as a mixture of multivariate normal density components); Self-organizing maps (which is uses neural networks that learn the topology and distribution of the data); and Hidden Markov models (which use observed data to recover sequence of states).

In block 263, the service 15 stores the list of disease-specific patient experience narratives (121) as a data object 21.

In block 265, the disease-specific patient experience narratives belonging to the list of disease-specific patient experience narratives stored in 263 are presented (displayed) to the patient user through operation of the remote computing device.

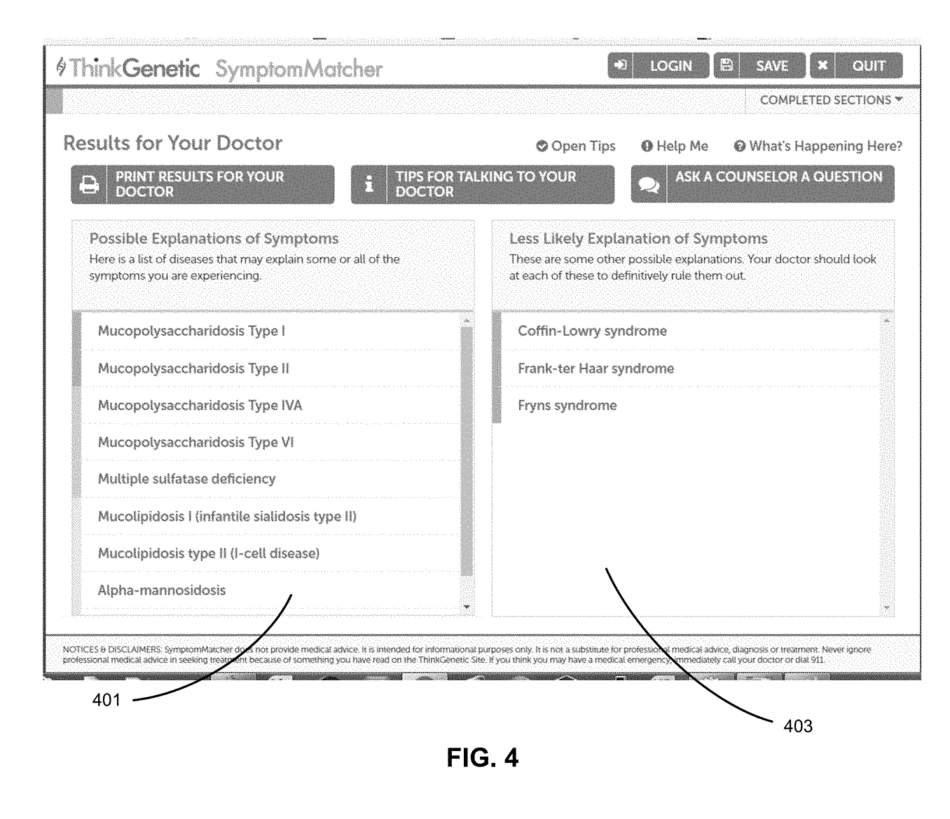

In block 267, the service 15 collects data representing affinity relationships pertaining to the presented (displayed) disease-specific patient experience narratives. The affinity relationships reflect different degrees of similarity between the disease-specific patient experience narratives and the experiences of the patient/user. Such affinity relationships are specified by input of the patient/user on the remote computing device. In embodiments, the presentation (display) of the disease-specific patient experience narratives can be organized as groups for the corresponding disease presentations or diseases. In an embodiment shown in FIG. 4, the affinity relationship for a given disease-specific patient experience narrative is specified from one of four possible options:
Option 1—not as all like, which equates to the situation where the disease-specific patient experience narrative is different from the experience of the patient/user;
Option 2—not much like, which equates to the situation where the disease-specific patient experience narrative is not very similar to the experience of the patient/user;
Option 3—somewhat like—which equates to the situation where the disease-specific patient experience narrative is somewhat similar to the experience of the patient/user; and
Option 4—a lot like—which equates to the situation where the disease-specific patient experience narrative is very similar to the experience of the patient/user.
   The patient/user can specify a particular affinity relationship by one or more predefined input actions, such as by highlighting/clicking the text representing the particular affinity relationship option itself or by clicking on a check box or field that is displayed adjacent text representing the particular affinity relationship option.

In block 271, the service 15 uses the data representing the affinity relationship(s) for the disease-specific patient experience narrative(s) specified by the user input in 267 and patient-specific information 106 input in 269 to evaluate and update the disease presentations or diseases in the list of disease presentations or diseases determined in 257. Such evaluation can exclude (or include) a particular disease presentation or disease in the list of disease presentations or diseases determined in 257 based on threshold criterion related to the user-specified affinity relationship(s) data for the disease-specific patient experience narrative(s) as well as patient-specific information 106 that corresponds to the particular disease presentation or disease. In embodiments, the predefined list of disease-specific patient experience narratives 104 stores link data for each respective patient experience narrative. The link data identifies or refers to one or more disease presentations or diseases that are related to (or having a matching relationship with) the respective patient experience narrative. The affinity relationships specified in 267 that pertain to a particular disease presentation or disease can be used to generate a score or strength indicator for the particular disease presentation or disease. For example, a narrative with an option 4 user-specified affinity relationship can generate a higher score than a narrative with an option 3 user-specified affinity relationship, which can generate a higher score than a narrative with an option 2 user-specified affinity relationship, which can generate a higher score than a narrative with an option 1 user-specified affinity relationship. The score can be normalized by a maximum possible value and the resultant score compared to a predefined threshold value. If the resultant score does not exceed the predefined threshold value, the particular disease presentation or disease can be excluded (removed) from the updated list of disease presentations or diseases. Otherwise (where the resultant score is equal to or exceeds the predefined threshold value), the particular disease presentation or disease can be included in the updated list of disease presentations or diseases.

In block 275, the disease to disease-specific symptom matching module 33 is configured, taking as input the list of related disease presentations or diseases 115 output from 271 and the patient-specific information 106 in 273, to generate a list of disease specific symptoms by identifying a collection of disease-specific symptoms that are related to one or more disease presentations or diseases of the list of related disease presentations or diseases output from 271. In embodiments, the disease to disease-specific symptom matching module 33 can employ computer-implemented rules that represent matching relationships between disease presentations or diseases and disease-specific symptoms as well as computer-implemented rules that represent matching relationships between the patient-specific information (106) and one or more disease-specific symptoms. Such computer-implemented rules can be evaluated to identify a collection of disease-specific symptoms that match the one or more disease presentations or diseases of the list of related disease presentations or diseases 115 output from 271 as well as the patient-specific information 106 input in 273, and each identified disease-specific symptom of the collection can be added to the list of disease-specific symptoms. The computer-implemented rules can be based on clinical evidence and/or expert opinions and/or information theory that support the matching relationships between disease presentations or diseases and disease-specific symptoms. In other embodiments, other machine knowledge systems, such as supervised machine learning systems and unsupervised machine learning systems, can be used. Supervised machine learning systems derive an inference function from labeled training data. The training data consist of a set of training examples, where each example is a pair consisting of an input object (typically a vector) and a desired output value (also called the supervisory signal). A supervised learning algorithm analyzes the training data and produces the inference function, which can be used for mapping new examples. An optimal scenario will allow for the algorithm to correctly determine the class labels for all feasible inputs. Unsupervised machine learning systems draw inferences from datasets consisting of input data without labeled responses. The most common unsupervised learning method is cluster analysis, which is used for exploratory data analysis to find hidden patterns or grouping in data. The clusters are modeled using a measure of similarity which is defined upon metrics such as Euclidean or probabilistic distance. Common clustering algorithms include: Hierarchical clustering (which builds a multilevel hierarchy of clusters by creating a cluster tree); k-Means clustering (which partitions data into k distinct clusters based on distance to the centroid of a cluster); Gaussian mixture models (which models clusters as a mixture of multivariate normal density components); Self-organizing maps (which is uses neural networks that learn the topology and distribution of the data); and Hidden Markov models (which use observed data to recover sequence of states).

In block 277, the service 15 stores the list of disease-specific symptoms (123) as a data object 21.

In block 279, the disease-specific symptoms belonging to the list of disease-specific symptoms stored in 277 are presented (displayed) to the patient user through operation of the remote computing device.

In block 281, the service 15 collects data representing user input regarding each disease-specific symptom in the list of disease-specific symptoms as presented (displayed) to the patient/user in 279. Such user input is specified by input of the patient/user on the remote computing device. In embodiments, the presentation (display) of the disease-specific symptoms can be organized in groups for the corresponding disease presentations or diseases. Furthermore, the presentation (display) of the disease-specific symptoms can be further organized according to the hierarchal structure of groups or classes for the disease-specific symptoms as discussed above. In embodiments, the user input for a respective disease-specific symptom provides one of three possibly indications, including i) the patient/user definitely has the respective disease-specific symptom (e.g., a “yes” input), ii) the patient/user definitely does not have the respective disease-specific symptom (e.g., a “no” input), or iii) the patient/user possibly has the respective disease-specific symptom (e.g., a “maybe” or “unsure” input). The patient/user can provide the user input for a particular disease-specific symptom by one or more predefined input actions, such as by clicking on a designated check box or field or icon indicating Yes, Unsure, or No that is displayed adjacent text representing the particular disease-specific symptom.

In block 285, the disease scoring module 35 is configured, taking as input the list of related disease presentations or diseases 115 output from 271 as well as the user input for the disease-specific symptoms dictated by the data collected in 281 and the patient-specific information 106 of 283, to score and rank or group the disease presentations or diseases of the list of related disease presentations or diseases based on such user input.

In embodiments, the disease scoring module 35 can employ a number of Bayesian inference models, one for each disease presentation or disease in the list 102 stored by the service 15. Note that all of the Bayesian inference models can be independent of one another. The Bayesian inference model for a particular disease presentation or disease is used to infer (determine) the posterior probability that the patient/user has (or does not have) the particular disease presentation or disease based on user input for the disease-specific symptoms collected in block 281 that pertain to the particular disease. The Bayesian interference model derives the posterior probability as a consequence of two antecedents, a prior probability that the patient/user has (or does not have) the particular disease presentation or disease and a “likelihood function” derived from a statistical model for the observed data (in the case, the user input for the disease-specific symptoms collected in block 281). This posterior probability can be used to determine a score or rank for the particular disease presentation or disease.

For example, the Bayesian inference model for a particular disease presentation or disease can include N number of disease-specific symptoms that are associated with the particular disease presentation or disease with a set of variables pertaining to each disease-specific symptom indexed by the integer i such that 1<=i<=N. In embodiments, the set of variables pertaining to each disease specific symptom i include the following:
Zᵢ, which represents whether or not the patient/user has or does not have the disease-specific symptom i; Zᵢ=1 can be used to represent that patient/user has the disease-specific symptom, and Zᵢ=−1 can be used to represent that patient/user does not have the disease-specific symptom i;
Hᵢ, which represents the frequency type of the disease-specific symptom i for people that have the particular disease presentation or disease; there are N such variables; Hᵢ can be assigned a value selected from a number predefined values that represent different frequency types (such as a hallmark frequency type, a common frequency type or a common frequency type); note that each Hᵢ is a parameter for computing the probabilities P(Z|D) as well as P(S) (see below);
Lᵢ, which represents the frequency type of the disease-specific symptom i for people that don't have the particular disease presentation or disease; there are N such variables; Lᵢ can be assigned a value selected from a number predefined values that represent different frequency types; note that each Lᵢ is a parameter for computing the probabilities P(Z|D) as well as P(S) (see below);
Si; which represents the user input for the disease-specific symptom i as collected in block 281; there are N such variables; Sᵢ=−1 can be used to represent that the patient/user reports as not having the disease-specific symptom i (“no” input); Sᵢ=0 can be used to represent that the patient/user reports as possibly having the disease-specific symptom i (“maybe” input); Sᵢ=1 can be used to represent that the patient/user reports as having the disease-specific symptom i (“yes” input); and
Aᵢ, which represents an awareness type of the symptom i; there are N such variables; Aᵢ is a parameter used to compute the probabilities P(Si|Z) (see below).
   The Bayesian inference model for the particular disease presentation or disease can employ a variable D to represent whether or not the patient/user has the particular disease presentation or disease. For example, the value of D=−1 can be used to indicate that the patient/user does not have the particular disease presentation or disease, and the value of D=1 can be used to indicate that the patient/user does have the particular disease presentation or disease.

The Bayesian inference model for the particular disease presentation or disease can also use a probability P(D), which represents the probability of the disease presentation or the disease (within a population) and which is derived from disease incidence data. The probability P(D) is different for each disease presentation or disease. The patient-specific information 106 (such as age, gender and ethnicity) can be used to determine the probability P(D) for the particular patient.

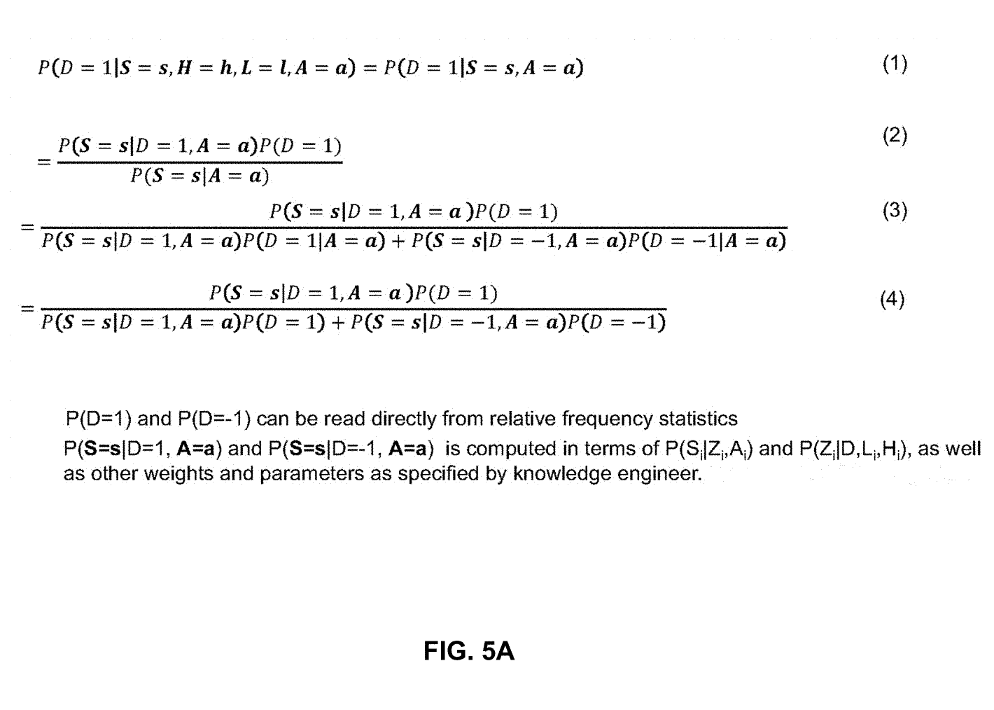

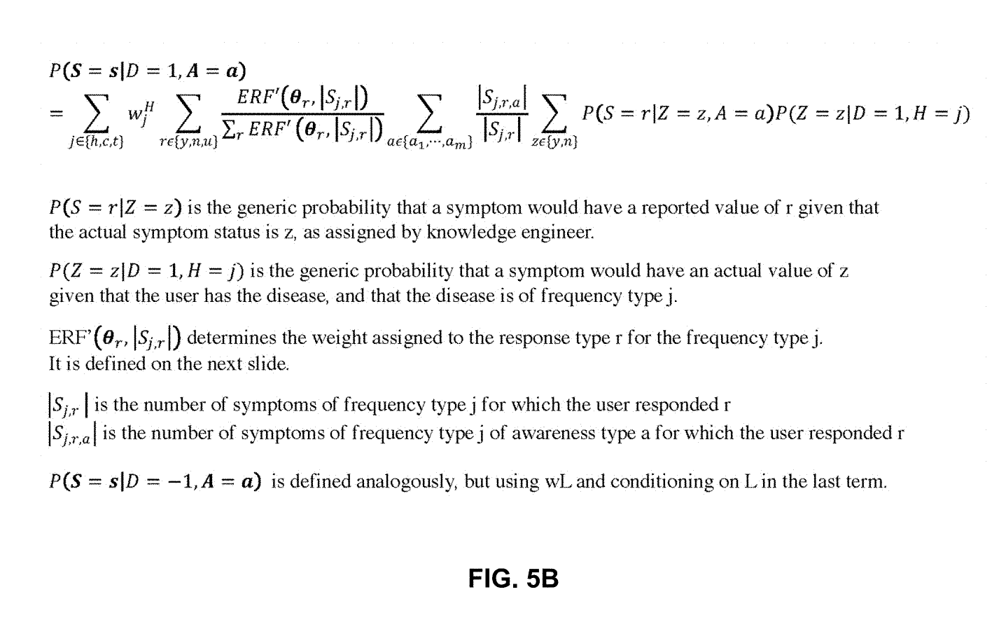

Bayes' theorem can be applied to this system of variables to provide the system of equations shown in FIG. 5A. Note that the conditional probabilities P (S|D, A) can be computed in terms of two conditional probability tables, P(Z|L, H, D) and P(S|Z, A). The conditional probability table P(Z|L, H, D) represents the probability of the variable Z given the values of L, H, D. This conditional probability table is the same for any value of i for the particular disease presentation or disease. In embodiments, the following context-specific conditional independence constraints can be enforced:
I_{D=1}(Z; L|H,D=1), i.e. P(Z|L, H, D=1)=P(Z|H, D=1)
I_{D=-1}(Z; H|L, D=−1), i.e. P(Z|L, H, D=−1)=P(Z|L, D=−1)

This conditional probability table can be fully specified by a knowledge engineer. The conditional probability table P(S|Z, A) represents the probability of the variable S given the values of Z and A. This conditional probability table is the same for any value of i for all diseases. This conditional probability table can be fully specified by a knowledge engineer. Note that for each symptom i, the values Lᵢ, Hᵢ, and Aᵢ can be set by medical experts with knowledge about the symptom and disease in question. Note that patient-specific information 106 (such as age) can be used to determine the values for the awareness parameter Aᵢ for the particular patient.

The system of equations shown in FIG. 5A for the Bayesian inference model of the particular disease can be solved for the probabilities P (S|D, A) based on the computations summarized in FIG. 5B. Such probabilities can be used to determine a score or rank for the particular disease presentation or disease.

In block 287, the service 15 evaluates threshold criterion pertaining to characteristics of the scores generated in 285 to determine if the threshold criterion is reached. For example, the threshold criteria can involve determining whether one or more disease presentations or disease satisfies a minimum threshold score. If the threshold criterion is not reached, the operations can revert back to blocks 229 and 231 where the patient/user is presented with broad symptoms and the service 15 collects data representing additional broad symptoms that are selected by the patient/user (or possibly reverts back to blocks 213 and 215 where the patient/user is presented with broad symptoms and the service 15 collects data representing broad symptoms that are selected by the patient/user). After some number of reversions of block 287 where the threshold criterion of 287 is not reached, the service 15 can notify the patient/user that the service is unable to identify a disease based on the inputs provided by the patient/user. The service 15 can optional provide contact details or other suggestions to the patient/user for how to proceed in this case. If the threshold criterion of 287 is reached, the operations continue to blocks 289, 291 and 293.

In block 289, the service 15 stores the ranked or grouped list of disease presentations or diseases as generated in 285 as a data object 21.

In block 291, the service 15 presents (displays) to the patient /user the diseases corresponding to the ranked or grouped list of disease presentations or diseases generated in 285 using the remote computing device. FIG. 4 illustrates an exemplary graphical user interface generated by the service 15 that presents (displays) a number of diseases corresponding to the ranked or grouped list of disease presentations or diseases in two columns 401 and 403 arranged side-by-side one another. The column 401 is a list of diseases corresponding to the ranked or grouped list of disease presentations or diseases, where such diseases are possible explanations of the disease-specific symptoms experienced by the patient/user. The column 403 is a list of diseases corresponding to the ranked or grouped list of disease presentations or diseases, where such diseases are less likely explanations of the disease-specific symptoms experienced by the patient/user. The diseases can be assigned to either one of the column list 401 or 403 by comparing the scores generated in 285 for the disease and certain threshold criteria that are designed to sufficiently classify diseases into the appropriate column list.

In block 293, the service 15 presents (displays) information (125) regarding next steps for the ranked or grouped list of diseases generated in 285 to the patient/user using the remote computing device. The next step information 125 can include information on how to prepare for doctor visit (which is sometimes referred to as a “tear-sheet”), researched medical information to share with the patient's doctor (which can be customized based on the user's inputs), and access to consumer health information about diseases.

As described herein, the operations that support disease diagnosis (including data storage) can be distributed between a client computing device and a server (such as a remote server connected to the client computer device over a network). For example, at least part of the operations that support disease diagnosis can be embodied in a client-side script downloaded from the remote server to the client computing device for execution on the client computing device. In another example, at least part of the operations that support disease diagnosis can be embodied in a server-side script or function executed by the remote server to the client computing device. The client computing device can execute an application (such as web browser) to carry out at least part of the operations that support disease diagnosis. Alternatively, the operations that support disease diagnosis (including data storage) can be carried out by a desktop application executing on a computing device.

Note that the interaction with the patient/user can involve the presentation of information by display as described herein. Alternatively, the presentation of such information can involve images, pictures, schematic illustrations, audio output (through standard text-to-speech processing) or other forms of other forms of output that describe or is otherwise related to broad symptoms, disease-specific symptoms, disease presentations and/or diseases. Further, the input provided by the patient/user can be provided by pointer devices (such as a mouse, trackpad, etc.). Alternatively, the input provided by the patient/user can involve speech input (through standard speech recognition processing) and other forms of input.

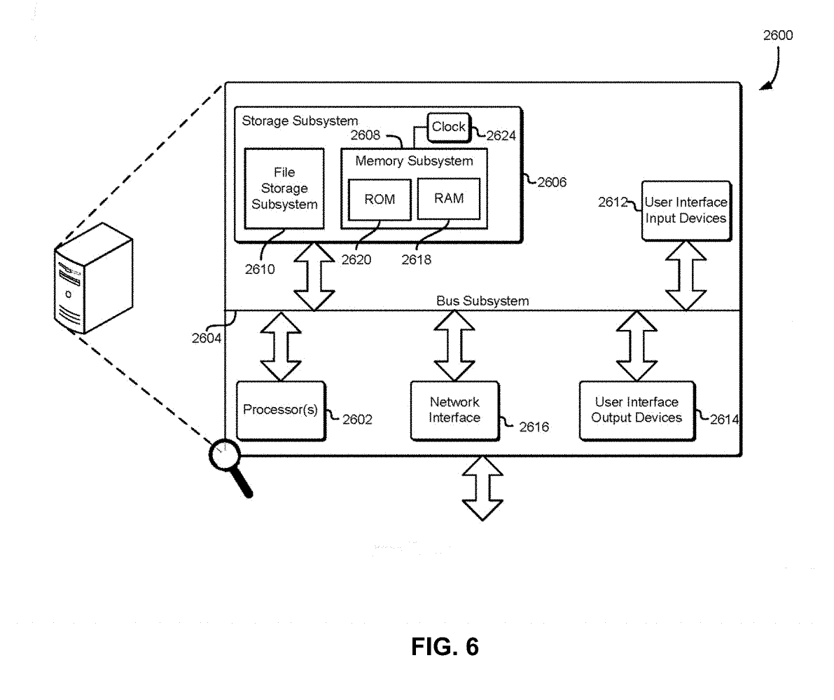

FIG. 6 is an illustrative, simplified block diagram of a computing device 2600 that may be used to practice at least one embodiment of the present disclosure. In various embodiments, the computing device 2600 may be used to implement any of the systems illustrated and described above. For example, the computing device 2600 may be configured for use as a data server, a web server, a portable computing device, a personal computer, or any electronic computing device. As shown in FIG. 6, the computing device 2600 may include one or more processors 2602 that may be configured to communicate with, and are operatively coupled to, several peripheral subsystems via a bus subsystem 2604. The processors 2602 may be utilized for part of the operations as described herein. The peripheral subsystems may include a storage subsystem 2606, comprising a memory subsystem 2608 and a file/disk storage subsystem 2610, one or more user interface input devices 2612, one or more user interface output devices 2614, and a network interface subsystem 2616.

The bus subsystem 2604 may provide a mechanism for enabling the various components and subsystems of computing device 2600 to communicate with each other as intended. Although the bus subsystem 2604 is shown schematically as a single bus, alternative embodiments of the bus subsystem may utilize multiple busses. The network interface subsystem 2616 may provide an interface to other computing devices and networks. The network interface subsystem 2616 may serve as an interface for receiving data from, and transmitting data to, other systems from the computing device 2600. For example, the network interface subsystem 2616 may enable a data technician to connect the device to a wireless network such that the data technician may be able to transmit and receive data while in a remote location, such as a user data center. The bus subsystem 2604 may be utilized for communicating data such as details, search terms, and so on to the supervised model of the present disclosure and may be utilized for communicating the output of the supervised model to the one or more processors 2602 and to merchants and/or creditors via the network interface subsystem 2616.

The user interface input devices 2612 may include one or more user input devices such as a keyboard; pointing devices such as an integrated mouse, trackball, touchpad, or graphics tablet; a scanner; a barcode scanner; a touch screen incorporated into the display; audio input devices such as voice recognition systems, microphones; and other types of input devices. In general, use of the term “input device” is intended to include all possible types of devices and mechanisms for inputting information to the computing device 2600. The one or more user interface output devices 2614 may include a display subsystem, a printer, or non-visual displays such as audio output devices, etc. The display subsystem may be a cathode ray tube (CRT), a flat-panel device such as a liquid crystal display (LCD), light emitting diode (LED) display, or a projection or other display device. In general, use of the term “output device” is intended to include all possible types of devices and mechanisms for outputting information from the computing device 2600. The one or more user interface output devices 2614 may be used, for example, to present user interfaces to facilitate user interaction with applications performing processes described and variations therein, when such interaction may be appropriate.

The storage subsystem 2606 may provide a computer-readable storage medium for storing the basic programming and data constructs that may provide the functionality of at least one embodiment of the present disclosure. The applications (programs, code modules, instructions), when executed by one or more processors, may provide the functionality of one or more embodiments of the present disclosure, and may be stored in the storage subsystem 2606. These application modules or instructions may be executed by the one or more processors 2602. The storage subsystem 2606 may additionally provide a repository for storing data used in accordance with the present disclosure. The storage subsystem 2606 may comprise a memory subsystem 2608 and a file/disk storage subsystem 2610.

The memory subsystem 2608 may include a number of memories, including random-access memory (RAM) 2618 for storage of instructions and data during program execution and a read only memory (ROM) 2620 in which fixed instructions may be stored. The file/disk storage subsystem 2610 may provide a non-transitory persistent (non-volatile) storage for program and data files and may include a hard disk drive, a floppy disk drive along with associated removable media, a Compact Disk Read Only Memory (CD-ROM) drive, an optical drive, removable media cartridges, and other like storage media.

The computing device 2600 may include at least one local clock 2624. The local clock 2624 may be a counter that represents the number of ticks that have transpired from a particular starting date and may be located integrally within the computing device 2600. The local clock 2624 may be used to coordinate data transfers between the computing device 2600 and other systems. In one embodiment, the local clock 2624 is an atomic clock. In another embodiment, the local clock is a programmable interval timer.

The computing device 2600 may be of various types, including a portable computer device, tablet computer, a workstation, or any other device described below. Additionally, the computing device 2600 may include another device that may be connected to the computing device 2600 through one or more ports (e.g., USB, a headphone jack, Lightning connector, etc.). The device that may be connected to the computing device 2600 may include a plurality of ports configured to accept fiber-optic connectors. Accordingly, this device may be configured to convert optical signals to electrical signals that may be transmitted through the port connecting the device to the computing device 2600 for processing. Due to the ever-changing nature of computers and networks, the description of the computing device 2600 depicted in FIG. 6 is intended only as a specific example for purposes of illustrating the preferred embodiment of the device. Many other configurations having more or fewer components than the system depicted in FIG. 6 are possible.

The specification and drawings are, accordingly, to be regarded in an illustrative rather than a restrictive sense. However, it will be evident that various modifications and changes may be made thereunto without departing from the scope of the invention as set forth in the claims. Likewise, other variations are within the scope of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions and equivalents falling within the scope of the invention, as defined in the appended claims.

The use of the terms “a” and “an” and “the” and similar referents in the context of describing the disclosed embodiments (especially in the context of the following claims) is to be construed to cover both the singular and the plural, unless otherwise indicated or clearly contradicted by context. The terms “comprising”, “having”, “including”, and “containing” are to be construed as open-ended terms (i.e., meaning “including, but not limited to”) unless otherwise noted. The term “connected”, when unmodified and referring to physical connections, is to be construed as partly or wholly contained within, attached to or joined together, even if there is something intervening. Recitation of ranges of values in the present disclosure are merely intended to serve as a shorthand method of referring individually to each separate value falling within the range unless otherwise indicated and each separate value is incorporated into the specification as if it were individually recited. The use of the term “set” (e.g., “a set of items”) or “subset”, unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal.

Conjunctive language, such as phrases of the form “at least one of A, B, and C”, or “at least one of A, B and C”, unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

Operations of processes described can be performed in any suitable order unless otherwise indicated or otherwise clearly contradicted by context. Processes described (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

The use of any and all examples, or exemplary language (e.g., “such as”) provided, is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described, including the best mode known to the inventors for carrying out the invention. Variations of those embodiments may become apparent to those of ordinary skill in the art upon reading the foregoing description. The inventors expect skilled artisans to employ such variations as appropriate and the inventors intend for embodiments of the present disclosure to be practiced otherwise than as specifically described. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated or otherwise clearly contradicted by context.

All references, including publications, patent applications, and patents, cited are hereby incorporated by reference to the same extent as if each reference were individually and specifically indicated to be incorporated by reference and were set forth in its entirety.

It should be noted that the above-mentioned embodiments illustrate rather than limit the invention, and that those skilled in the art will be capable of designing many alternative embodiments without departing from the scope of the invention, as defined by the appended claims. In the claims, any reference signs placed in parentheses shall not be construed as limiting the claims. The words “comprising”, “comprises”, and the like do not exclude the presence of elements or steps other than those listed in any claim or the specification as a whole. In the present specification, “comprises” means “includes or consists of” and “comprising” means “including or consisting of”. The singular reference of an element does not exclude the plural reference of such elements and vice-versa. The invention may be implemented by means of hardware comprising several distinct elements and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

What is claimed is:

1. A computer-implemented method for supporting disease diagnosis, comprising:
a) generating and storing a list of user-selected broad symptoms;
b) using the list of user-selected broad symptoms to generate and store a list of related disease presentations or diseases;
c) using at least one machine knowledge system to identify a collection of disease-specific symptoms that are related to the disease presentations or diseases of the list of related disease presentations or diseases;
d) presenting to the user disease-specific symptoms belonging to the collection of disease-specific symptoms for associated user input;
e) using the user input associated with the disease-specific symptoms to determine matching scores for diseases presentations or diseases of the list of related disease presentations or diseases; and
f) using the matching scores for the diseases presentations or diseases to present to the user rankings or groupings for diseases corresponding to the of the list of related disease presentations or diseases.

2. The method of claim 1, wherein:
the user input associated with a respective disease-specific symptom is selected from the group comprising: i) an indication that the patient/user reports having the respective disease-specific symptom, ii) an indication that the patient/user reports not having the respective disease-specific symptom, and iii) an indication that the patient/user reports possibly having the respective disease-specific symptom.

3. The method of claim 1, wherein:
the list of user-selected broad symptoms is derived from an initial list of broad symptoms that relate to patient-specific information input by the user.

4. The method of claim 3, wherein:
the at least one machine knowledge system identifies the collection of disease-specific symptoms based on the patient-specific information input by the user.

5. The method of claim 1, wherein:
the at least one machine knowledge system employs computer-implemented rules that represent matching relationships between disease presentations or diseases and disease-specific symptoms.

6. The method of claim 3, wherein the collection of disease-specific symptoms is generated in c) by:
using a first machine knowledge system that identifies a collection of disease-specific patient experience narratives that are related to disease presentations or diseases in an initial list of related disease presentations or diseases; and
presenting to the user disease-specific patient experience narratives belonging to the collection of disease-specific patient experience narratives for associated user input;
using the user input associated with the disease-specific patient experience narratives to update the list of related disease presentations or diseases;
using a second machine knowledge system that identifies a collection of disease-specific symptoms that are related to the updated list of related disease presentations or diseases.

7. The method of claim 6, wherein:
the user input associated with a given disease-specific patient experience narrative represents an affinity relationship selected from a plurality of affinity relationships that reflect different degrees of similarity between the disease-specific patient experience narrative and the experiences of the patient/user.

8. The method of claim 7, wherein:
the plurality of affinity relationships specify one of four possible options, including: a first option which equates to the situation where the disease-specific patient experience narrative is different from the experience of the patient/user; a second option which equates to the situation where the disease-specific patient experience narrative is not very similar to the experience of the patient/user; a third option which equates to the situation where the disease-specific patient experience narrative is somewhat similar to the experience of the patient/user; and fourth option which equates to the situation where the disease-specific patient experience narrative is very similar to the experience of the patient/user.

9. The method of claim 6, wherein:
the first machine knowledge system identifies the collection of disease-specific patient experience narratives based on the patient-specific information input by the user; and/or
the second machine knowledge system identifies the collection of disease-specific symptoms based on the patient-specific information input by the user.

10. The method of claim 6, wherein:
the first machine knowledge system employs computer-implemented rules that represent matching relationships between disease presentations or diseases and disease-specific patient experience narratives; and/or
the second machine knowledge system employs computer-implemented rules that represent matching relationships between disease presentations or diseases and disease-specific symptoms.

11. The method of claim 3, wherein list of user-selected broad symptoms is generated in a) by:
presenting to the user broad symptoms for selection by the user in order to generate and store a first list of broad symptoms that have been selected by the user;
using a third machine knowledge system to generate an initial list of related disease presentations or diseases by identifying one or more disease presentations or diseases that are related to the broad symptoms of the first list of broad symptoms;
using a fourth machine knowledge system to identify a collection of diseases-related broad symptoms that are related to the disease presentations or diseases of the initial list of related disease presentations or diseases;
presenting to the user diseases-related broad symptoms belonging to the collection of diseases-related broad symptoms for selection by the user; and
updating the initial list of related disease presentations or diseases based on user-selections of the diseases-related broad symptoms.

12. The method of claim 11, wherein:
the third machine knowledge system identifies the one or more disease presentations or diseases based on the patient-specific information input by the user; and/or
the fourth machine knowledge system identifies the collection of diseases-related broad symptoms based on the patient-specific information input by the user.

13. The method of claim 11, wherein:
the third machine knowledge system employs computer-implemented rules that represent matching relationships between broad symptoms and disease presentations or diseases; and/or
the fourth machine knowledge system employs computer-implemented rules that represent matching relationships between disease presentations or diseases and broad symptoms.

14. The method of claim 1, wherein:
the disease-specific symptoms of the list of disease-specific symptoms are presented to the user in d) before presenting any diseases to the user.

15. The method of claim 1, wherein which is configured to provide at least one feature selected from the group comprising:
i) at least part of the method is carried out by a client computing device in conjunction with a remote server;
ii) at least part of the method is embodied in a client-side script downloaded from the remote server to the client computing device for execution on the client computing device;
iii) at least part of the method is embodied in a server-side script or function executed by the remote server;
v) a client computing device executes an application (such as web browser) to carry out the method; and
v) at least part of the method is carried out by a desktop application executing on a computing device.

16. A system for supporting disease diagnosis, comprising:
at least one computer processing platform that is configured to carry out a sequence of operations that include
a) generating and storing a list of user-selected broad symptoms;
b) using the list of user-selected broad symptoms to generate and store a list of related disease presentations or diseases;
c) using at least one machine knowledge system to identify a collection of disease-specific symptoms that are related to the disease presentations or diseases of the list of related disease presentations or diseases;
d) presenting to the user disease-specific symptoms belonging to the collection of disease-specific symptoms for associated user input;
e) using the user input associated with the disease-specific symptoms to determine matching scores for diseases presentations or diseases of the list of related disease presentations or diseases; and
f) using the matching scores for the diseases presentations or diseases to present to the user rankings or groupings for diseases corresponding to the of the list of related disease presentations or diseases.

17. The system of claim 16, wherein:
the at least one computer processing platform is part of service that is operably coupled to a remote client computer device via data exchange over at least one communication network.
